(19) United States
(12) Patent Application Publication
(10) Pub. No.: US 2011/0069004 A1
(43) Pub. Date: Mar. 24, 2011

(54) REMOTE CONTROLLER SUPPORTING SYSTEM AND METHOD FOR PROVIDING WEB SERVICE OPTIMIZED FOR REMOTE CONTROLLER

(75) Inventors: Jun Kyun Choi, Daejeon (KR); Jinhong Yang, Daejeon (KR); Hyojin Park, Daejeon (KR); Kyong-Il Cho, Gyeonggi-do (KR); Jaecheol Sim, Daejeon (KR); Kee Seong Cho, Daejeon-si (KR); Won Ryu, Daejeon-si (KR)

(73) Assignees: Korea Advanced Institute of Science and Technology, Daejeon (KR); Electronics and Telecommunications Research Institute, Daejeon (KR)

(21) Appl. No.: 12/694,460

(22) Filed: Jan. 27, 2010

(30) Foreign Application Priority Data
Sep. 21, 2009 (KR) 10-2009-0089271
Nov. 6, 2009 (KR) 10-2009-0106865

(51) Int. Cl. G09G 5/00; G06F 15/16

(52) U.S. Cl. 345/156; 709/219

(57) ABSTRACT

Provided is a remote controller supporting system and method that may provide a web service optimized for a remote controller of a user by displaying a webpage with different functions according to functions of each remote controller. The remote controller supporting system may include: a webpage storage unit to store a different webpage for each remote controller according to functions supportable by each remote controller; and a function controller to transmit remote controller group information containing remote controllers and webpage information corresponding to each of the remote controllers, and to transmit a webpage corresponding to a remote controller used in a system receiving the remote controller group information according to a request of the system.

### CROSS-REFERENCE TO RELATED APPLICATIONS

This application claims the benefit of Korean Patent Application No. 10-2009-0089271, filed on Sep. 21, 2009, and Korean Patent Application No. 10-2009-0106865, filed on Nov. 6, 2009, in the Korean Intellectual Property Office, the disclosures of which are incorporated herein by reference.

### BACKGROUND

1. Field of the Invention

The present invention relates to a system and method that may provide a web service optimized for a remote controller of a user by displaying a webpage with different functions according to functions of each remote controller.

2. Description of the Related Art

With developments of networks and displays such as a television (TV), an Internet

Protocol TV (IPTV) and products enabling a user to check websites even on a TV screen have appeared.

Unlike an input device for a computer such as a keyboard or a mouse having a common input signal and function, an input device for a TV such as a remote controller includes a special device or button.

For example, the remote controller may be used to manipulate the TV by including a gyro sensor or a three-axial sensor, and by measuring a rotation of the remote controller or a gradient of the scope.

Accordingly, when a website is optimized for a general remote controller, the remote controller having the special device or button may be limited to employ all the functions.

When the website is optimized for the remote controller having the special device or button, a user using the general remote controller may not easily manipulate the functions.

Accordingly, there is a need for a system and method that may provide a website satisfactorily used by both a user using a special remote controller and a user using a general remote controller.

### SUMMARY

An aspect of the present invention provides a system and method that may provide a web service optimized for a remote controller of a user by managing a webpage with different functions according to functions of each remote controller, and by transmitting a webpage suitable for the remote controller of the user based on functions included in the remote controller of the user.

Another aspect of the present invention also provides a system and method that may provide a web service optimized for a remote controller of a user by enabling a remote controller supporting system to combine functions available in the remote controller of the user, to recreate a webpage, and to display the recreated webpage when a web server transmits all the available functions.

According to an aspect of the present invention, there is provided a remote controller supporting system, including: a webpage storage unit to store a different webpage for each remote controller according to functions supportable by each remote controller; and a function controller to transmit remote controller group information containing remote controllers and webpage information corresponding to each of the remote controllers, and to transmit a webpage corresponding to a remote controller used in a system receiving the remote controller group information according to a request of the system.

According to another aspect of the present invention, there is provided a remote controller supporting system, including: a profile storage unit to store a plurality of profiles containing functions of remote controllers and information associated with the functions; a receiver to receive an input signal from a predetermined remote controller, and to interpret a meaning of the input signal based on a profile corresponding to the predetermined remote controller; an event unit to transform the meaning of the input signal to an event form; and a presentation unit to access a web server to display a webpage, to transform, to a predetermined behavior, at least one event transformed by the event unit, and to request the web server for an operation corresponding to the behavior. The presentation unit may receive information associated with functions of the webpage from the web server to display the webpage where the functions of the webpage are matched with the respective functions of the predetermined remote controller.

The web server may provide the presentation unit with integral information associated with all functions supportable by the webpage.

The function matching unit may compare the integral information with the profiles to extract information corresponding to the predetermined remote controller, may recreate the webpage so that the functions of the webpage are matched with the respective functions of the predetermined remote controller, and may display the recreated webpage.

According to still another aspect of the present invention, there is provided a remote controller supporting method, including: storing and setting a different webpage for each remote controller according to functions supportable by each remote controller; transmitting remote controller group information containing remote controllers and webpage information corresponding to each of the remote controllers; and transmitting a webpage corresponding to a remote controller used in a system receiving the remote controller group information according to a request of the system.

According to yet another aspect of the present invention, there is provided a remote controller supporting method, including: receiving, from a web server, integral information associated with all functions supportable by a webpage included in the web server; comparing the integral information with functions of a using remote controller to extract information corresponding to the using remote controller; recreating the webpage so that functions of the webpage are matched with the respective functions of the remote controller based on the extracted information; and displaying the recreated webpage.

According to embodiments of the present invention, it is possible to provide a web service optimized for a remote controller of a user by managing a webpage with different functions according to functions of each remote controller, and by transmitting a webpage suitable for the remote controller of the user based on functions included in the remote controller of the user.

Also, according to embodiments of the present invention, it is possible to provide a web service optimized for a remote controller of a user by enabling a remote controller supporting system to combine functions available in the remote controller of the user, to recreate a webpage, and to display the recreated webpage when a web server transmits all the available functions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects, features, and advantages of the invention will become apparent and more readily appreciated from the following description of exemplary embodiments, taken in conjunction with the accompanying drawings of which:

FIG. 1 is a block diagram illustrating a remote controller supporting system according to an embodiment of the present invention;

FIG. 2 is a block diagram illustrating a configuration of a presentation unit and a web server of FIG. 1;

FIG. 3 is a diagram illustrating a difference between a behavior and an event used in the remote controller supporting system of FIG. 1 according to an embodiment of the present invention;

FIG. 4 is a flowchart illustrating a remote controller supporting method according to an embodiment of the present invention;

FIG. 5 is a flowchart illustrating an example of an operation of verifying functions and displaying a webpage of FIG. 4;

FIG. 6 is a flowchart illustrating another example of the operation of verifying the functions and displaying the webpage of FIG. 4;

FIG. 7 is a flowchart illustrating an operation of interpreting an input signal of FIG. 4; and

FIG. 8 is a flowchart illustrating a method of recognizing, by a remote controller supporting system, a new remote controller according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to embodiments of the present invention, it is possible to provide a web service optimized for a remote controller of a user by displaying a webpage with different functions according to functions of each remote controller.

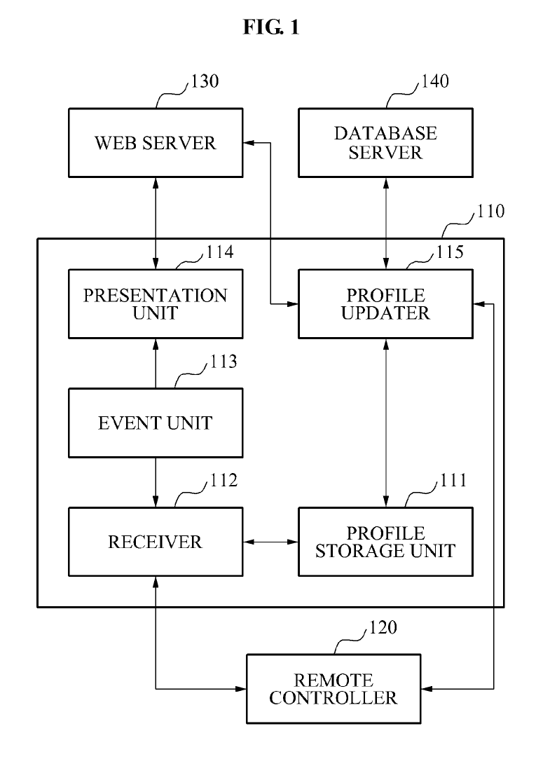

FIG. 1 is a block diagram illustrating a remote controller supporting system 110 according to an embodiment of the present invention.

As shown in FIG. 1, the remote controller supporting system 110 may include a profile storage unit 111, a receiver 112, an event unit 113, a presentation unit 114, and a profile updater 115.

The profile storage unit 111 may include a plurality of profiles containing functions and information associated with the functions of a remote controller 120.

Each of the profiles may include functions of a remote controller of a different type and information associated with the functions.

The receiver 112 may receive an input signal from the remote controller 120, and interpret a meaning of the input signal based on a profile corresponding to the remote controller 120.

Specifically, when the receiver 112 receives the input signal from the remote controller 120, the receiver 112 may identify a type of the remote controller 120 based on the received input signal, retrieve the profile corresponding to the remote controller 120 from the profile storage unit 111, and interpret the meaning of the input signal based on the retrieved profile corresponding to the remote controller 120.

For example, when a predetermined key of the remote controller 120 is selected, the receiver 112 may interpret that the predetermined key is selected based on the input signal.

When the receiver 112 may not identify the type of the remote controller 120 based on the received input signal, the receiver 112 may receive, from a user, a predetermined pattern with respect to the remote controller 112.

When the profile corresponding to the remote controller 120 does not exist in the profile storage unit 111, the receiver 112 may execute the profile updater 115 to store a new profile corresponding to the remote controller 120 in the profile storage unit 111.

The event unit 113 may transform the interpreted meaning of the input signal to an event form, and may store and mange a corresponding event.

For example, when the receiver 112 interprets that the meaning of the input signal indicates a predetermined key is selected, the event unit 113 may transform the input signal to an event indicating the predetermined key is selected, and may store the event. In this instance, the event unit 113 may store, in an internal storage device, a name of the event and a value of the event.

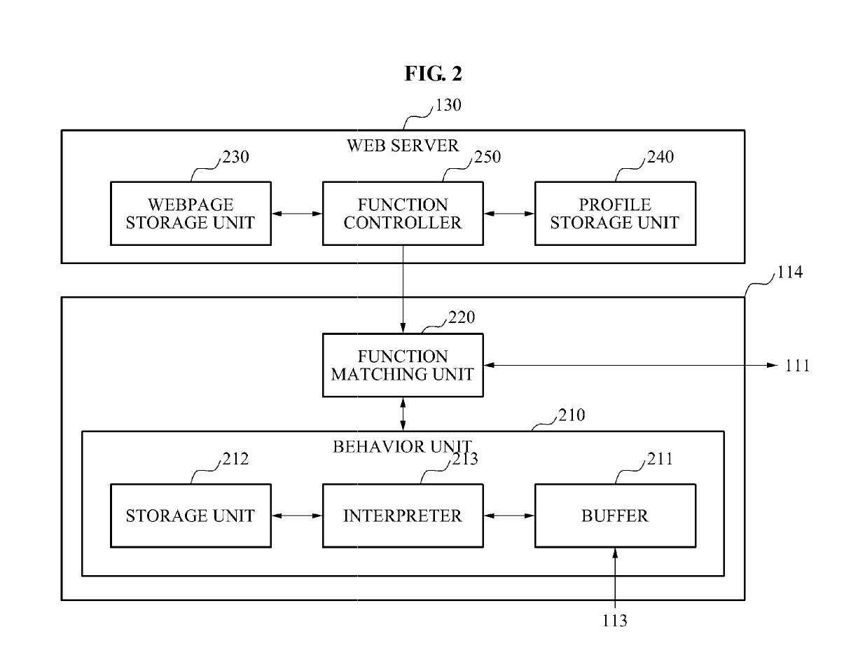

The presentation unit 114 may access a web server 130 to display a webpage, may transform, to a predetermined behavior, at least one event interpreted by the receiver 112, and may transmit an operation command corresponding to the behavior to the web server 130 to perform a corresponding operation on the webpage. For example, the presentation unit 114 may store the verified behavior in a storage unit 212 of FIG. 2, periodically perform polling with respect to behaviors stored in the storage unit 212, and transmit, to the web server 130, an operation command corresponding to the polled behavior.

In this instance, the presentation unit 114 may receive information associated with functions of the webpage from the web server 130, and may display the webpage where the functions of the webpage are matched with the respective functions of the remote controllers 120. Information transmitted from the web server 130 may include integral information associated with all the functions supportable by the webpage, or remote controller group information where a plurality of remote controllers is grouped into at least one remote controller group based on supportable functions of each remote controller.

A configuration and an operation of the presentation unit 114 and the web server 130 will be further described with reference to FIG. 2.

According to a request of the receiver 112, the profile updater 115 may access an external storage medium storing a new profile to download the new profile, and may store the downloaded new profile in the profile storage unit 111. In this instance, the profile updater 115 may select and access at least one of external storage media based on the identified remote controller type.

The external storage medium storing the new profile may correspond to one of a storage unit of the remote controller 120, the web server 130, and a database server 140. For example, the remote controller 120 may store its own profile in the storage unit of the remote controller 120. The web server 130 may store profiles with respect to remote controllers supportable over the webpage. The database server 140 may exclusively store the profiles.

The web server 130 may provide the presentation unit 114 with the integral information associated with all the functions supportable by the webpage.

In the integral information, a plurality of functions may be set with respect to the same object of the webpage based on the supportable functions of the webpage. For example, a motion function using a channel change key and a volume control key of a general remote controller, or a motion key using a sensor of a remote controller with a gyro sensor or a three-axial sensor may be set on a cursor of a screen. In this instance, the cursor may move using the key or the sensor on the webpage based on a function of the remote controller 120.

The web server 130 may group a plurality of remote controllers based on functions supportable by each remote controller to generate at least one remote controller group, may store a different webpage for each of the at least one remote controller group, and may provide remote controller group information to the presentation unit 114.

The web server 130 providing the remote controller group information to the presentation unit 114 will be further described with reference to FIG. 2.

FIG. 2 is a block diagram illustrating a configuration of the presentation unit 114 and the web server 130 of FIG. 1.

As shown in FIG. 2, the presentation unit 114 may include a behavior unit 210 and a function matching unit 220.

The behavior unit 210 may transform, to a predetermined behavior, at least one event stored in the event unit 113, and may request the web server 130 for an operation corresponding to the transformed behavior.

The behavior unit 210 may include a buffer 211, the storage unit 212, and an interpreter 213.

The buffer 211 may sequentially receive an event from the event unit 113 and store the received event in a received sequence. The event unit 113 may transmit the event to the buffer 211 in an interpreted sequence of the receiver 112.

The storage unit 212 may store a behavior list and behaviors transformed by the interpreter 213. The behavior list may include behaviors and at least one event corresponding to each of the behaviors.

The interpreter 213 may compare the at least one event stored in the buffer 211 with the behavior list. When the behavior list includes a behavior matching the at least one event, the interpreter 213 may transform the at least one event to the corresponding behavior. The interpreter 213 may transform N events to M behaviors. Here, N and M denote different integers.

The interpreter 213 may delete, from the buffer 211, the at least one event transformed to the corresponding behavior, and thereby may prevent a portion of the transformed at least one event from combining with another event and being transformed to another behavior.

When the presentation unit 114 is connected to the web server 130, the interpreter 213 may retrieve and load, from the storage unit 212, a behavior list used in the web server 230, and may compare the loaded behavior list with at least one event stored in the buffer 211.

The webpage of the web server 130 connected by the interpreter 213 may include a document in a JavaScript format performing an operation according to a request of the behavior unit 210.

The interpreter 213 may interpret a HyperText Markup Language (HTML) and a Cascading Style Sheet (CSS) of the webpage to process a corresponding event.

The function matching unit 220 may access the web server 130 to receive information associated with functions of the webpage from the web server 130, and may display the webpage where the functions of the webpage are matched with respective functions of the remote controller 120.

In this instance, the function matching unit 220 may extract a function corresponding to the same class through a comparison between the profile of the remote controller 120 and the integral information, using an Extensible Stylesheet Language Transformation (XSLT) technology.

When the integral information is received from the web server 130, the function matching unit 220 may compare the integral information with a profile of the remote controller 120, stored in the profile storage unit 111, to extract information corresponding to the remote controller 120, and may recreate and display the webpage so that the functions of the webpage are matched with the respective functions of the remote controller 120.

For example, when the remote controller 120 has functions a and b′, and the integral information includes an object a, supporting functions a, a′, and a″, and an object b supporting functions b and b′, the function matching unit 220 may select the object a supporting the function a, and the object b supporting the function b′, and may recreate the webpage so that the selected objects a and b may be displayed.

Also, when remote controller group information is received from the web server 130, the function matching unit 220 may compare the remote controller group information with the stored profile of the remote controller 120 to verify a remote controller group including the remote controller 120, may load a webpage corresponding to the remote controller 120 from the web server 130, and may display the loaded webpage.

As shown in FIG. 2, the web server 130 may include a webpage storage unit 230, a profile storage unit 240, and a function controller 250.

The webpage storage unit 230 may store a different webpage for each remote controller based on functions supportable by each remote controller. On the stored webpage, a display screen may be the same whereas a key or a function matching each object may be different.

The profile storage unit 240 may correspond to an online storage medium or an offline storage medium storing profiles of remote controllers supported by the web server 130.

The function controller 250 may transmit, to the function matching unit 220, remote controller group information including a remote controller list and webpage information corresponding to each remote controller, and may transmit, to the profile storage unit 240, a webpage corresponding to the remote controller 120 according to a request of the function matching unit 220.

The function controller 250 may set a different webpage for each remote controller based on the profile, and may store the set webpage in the webpage storage unit 230.

When the web server 130 transmits the remote controller group information, the function controller 250 may group a plurality of remote controllers based on profiles of the remote controllers, stored in the profile storage unit 240, to generate at least one remote controller group, and may set a different webpage for each of the at least one remote controller group and store the set webpage in the webpage storage unit 230. The function controller 250 may transmit, to the function matching unit 220 via the function controller 250, remote controller group information including the remote controller group list and webpage information corresponding to each remote controller.

The function matching unit 220 may compare the received remote controller group information with the profile of the remote controller 120, stored in the profile storage unit 111, to verify a remote controller group including the remote controller 120, may retrieve a webpage corresponding to the remote controller group from the webpage storage unit 230 based on the remote controller group information, may load, from the webpage storage unit 230, a webpage corresponding to the retrieved remote controller group, and may display the loaded webpage.

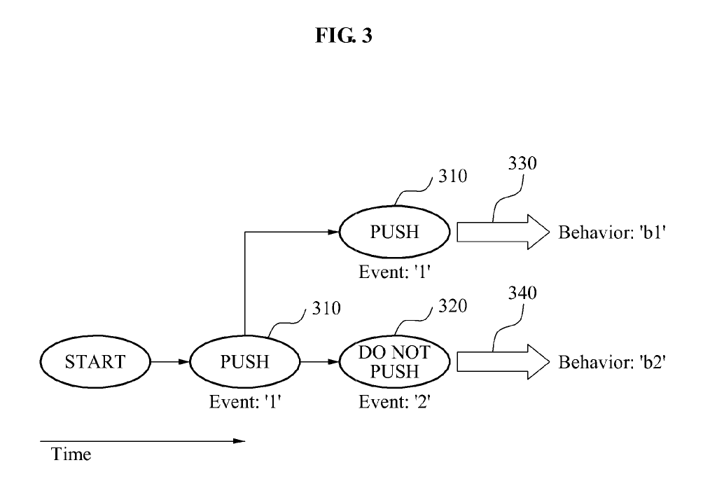

FIG. 3 is a diagram illustrating a difference between a behavior and an event used in the remote controller supporting system 110 according to an embodiment of the present invention.

Referring to FIG. 3, when a predetermined key is being pushed during a predetermined period of time, the remote controller supporting system 110 may set a corresponding behavior 1 to b1. When the predetermined key is pushed only once, the remote controller supporting system 110 may set a corresponding behavior 2 to b2.

When the user pushes the predetermined key of the remote controller 120, the receiver 112 receiving an input signal may interpret an event (1) 310 indicating the predetermined key is pushed, and may transfer the interpretation result to the event unit 113. The event unit 113 may store the event (1) 310 in the buffer 211.

In this example, when the user keeps pushing the predetermined key, the receiver 112 receiving the input signal may interpret the event (1) 310 indicating the predetermined key is pushed, and may continuously transfer the interpretation result to the event unit 113. The event unit 113 may continuously store the event (1) 310 in the buffer 211. In this instance, when the event (1) 310 is continuously stored in the buffer 211 more than a predetermined number of times, the interpreter 213 may determine the user is pushing the predetermined key during the predetermined period of time and thereby transform the event (1) 310 to behavior 1 (b1) as indicated by an arrow 330.

When the user takes a finger off from the predetermined key of the remote controller 120, the receiver 112 receiving an input signal may interpret an event (2) 320 indicating the predetermined key is not pushed, and transfer the interpretation result to the event unit 113. The event unit 113 may store, in the buffer 211, the event (2) 320 after the event (1) 310. In this instance, when the event (1) 310 and the event (2) 320 are sequentially stored in the buffer 211, the interpreter 213 may determine the predetermined key is pushed only once and thereby may transform the event (1) 310 and the event (2) 320 to behavior 2 (b2) as indicated by an arrow 340.

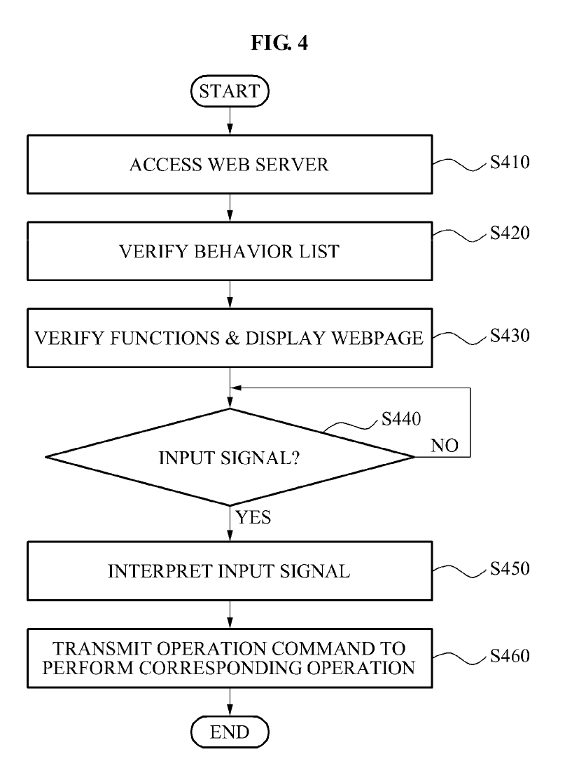

FIG. 4 is a flowchart illustrating a remote controller supporting method according to an embodiment of the present invention.

In operation S410, the presentation unit 114 may access the web server 130 according to a user request. The function matching unit 220 included in the presentation unit 114 may load a webpage of the web server 130 and temporarily store the loaded webpage.

In operation S420, the presentation unit 114 may verify a behavior list available in the web server 130.

In operation S430, the presentation unit 114 may receive information associated with functions of the webpage from the web server 130 to verify functions supportable in the remote controller 120, and may display the webpage where the functions of the webpage are mapped with respective functions of the remote controller 120.

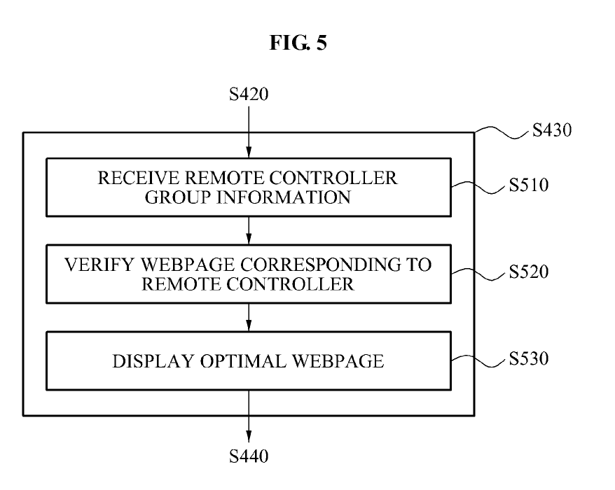

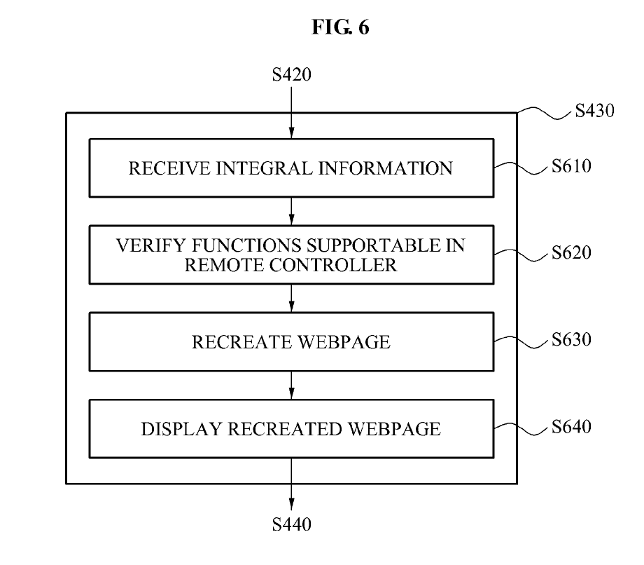

Operation S430 of verifying functions and displaying the webpage will be further described with reference to FIGS. 5 and 6.

In operation S440, the receiver 112 may verify whether an input signal is received from the remote controller 120. When the input signal is not received, the receiver 112 may be in an idle state.

In operation S450, the presentation unit 114 may interpret the received input signal to verify a behavior requested by the user using the behavior list. In this instance, the presentation unit 114 may store the verified behavior in the storage unit 212.

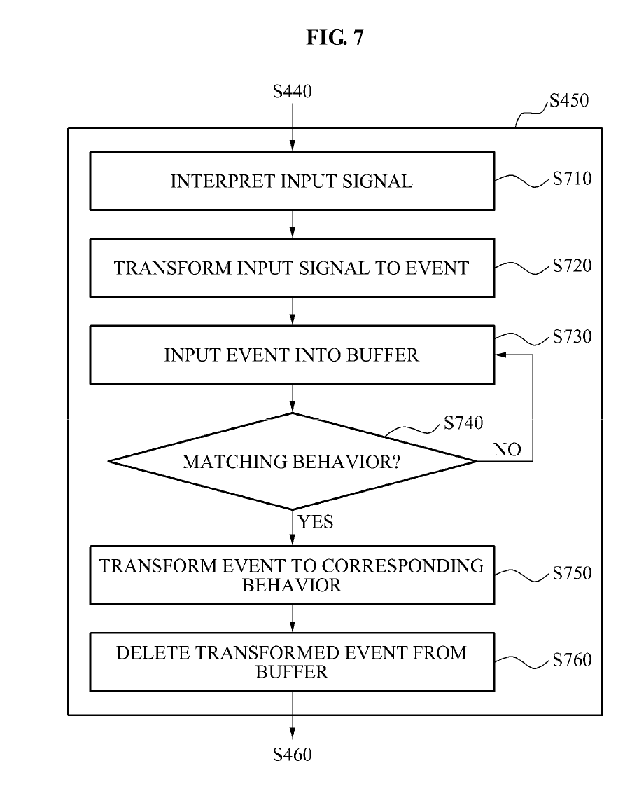

Operation S450 of interpreting the input signal will be further described with reference to FIG. 7.

In operation S460, the presentation unit 114 may transmit an operation command corresponding to the verified behavior to the web server 130 to perform a corresponding operation in the webpage. The presentation unit 114 may periodically perform polling with respect to behaviors stored in the storage unit 212, and may transmit, to the web server 130, an operation corresponding to the polled behavior.

FIG. 5 is a flowchart illustrating an example of operation S430 of verifying functions and displaying a webpage of FIG. 4. Operations S510 through S530 may be included in operation S430.

In operation S510, the function matching unit 220 may receive, from the web server 130, remote controller group information including remote controllers and webpage information corresponding to each of the remote controllers.

In operation S520, the function matching unit 220 may compare the received remote controller group information with a profile of the remote controller 120, stored in the profile storage unit 111, to verify a webpage corresponding to the remote controller 120.

In operation S530, the function matching unit 220 may retrieve the verified webpage from the webpage storage unit 230, and may load the retrieved webpage to display the loaded webpage.

FIG. 6 is a flowchart illustrating another example of operation S430 of verifying functions and displaying the webpage of FIG. 4. Operations S610 through S640 may be included in operation S430 of FIG. 4.

Referring to FIG. 6, a method of verifying functions and displaying the webpage when the web server 130 transmits integral information is provided.

In operation S610, the function matching unit 220 may receive, from the web server 130, integral information associated with all functions supportable by the webpage.

In the integral information, a plurality of functions may be set with respect to the same object of the webpage based on the supportable functions of the webpage. For example, a motion function using a channel change key and a volume control key of a general remote controller, or a motion key using a sensor of a remote controller with a gyro sensor or a three-axial sensor may be set on a cursor of a screen.

In operation S620, the function matching unit 220 may compare the received integral information with a profile of the remote controller 120, stored in the profile storage unit 111, to verify functions supportable in the remote controller 120. Specifically, the function matching unit 220 may extract the same class through a comparison between the received integral information and the profile of the remote controller 120, using an XSLT technology, and may verify the extracted class as functions supportable in the remote controller 120.

In operation S630, the function matching unit 220 may render objects of the webpage and recreate the webpage so that the verified functions may be optimized.

In operation S640, the function matching unit 220 may display the recreated webpage. FIG. 7 is a flowchart illustrating operation S450 of interpreting the input signal of FIG. 4.

Operation S710 through S760 may be included in operation S450.

In operation S710, the receiver 112 may identify a type of the remote controller 120 based on the received input signal, may retrieve, from the profile storage unit 111, a profile corresponding to the identified type of the remote controller 120, and may interpret an event of the input signal based on the retrieved profile.

In operation S720, the receiver 112 may transform the received input signal to an event based on the interpreted event of the input signal, and store the transformed event in the event unit 113.

In operation S730, the event unit 113 may sequentially input the stored event into the buffer 211.

In operation S740, the interpreter 213 may compare at least one event stored in the buffer 211 with the verified behavior list, and may verify whether the behavior list includes a behavior matching the at least one event.

In operation S750, the interpreter 213 may transform, to the corresponding behavior, the at least one event verified to match the behavior.

The interpreter 213 may store the transformed behavior in the storage unit 212.

In operation S760, the interpreter 213 may delete, from the buffer 211, the at least one event transformed to the behavior.

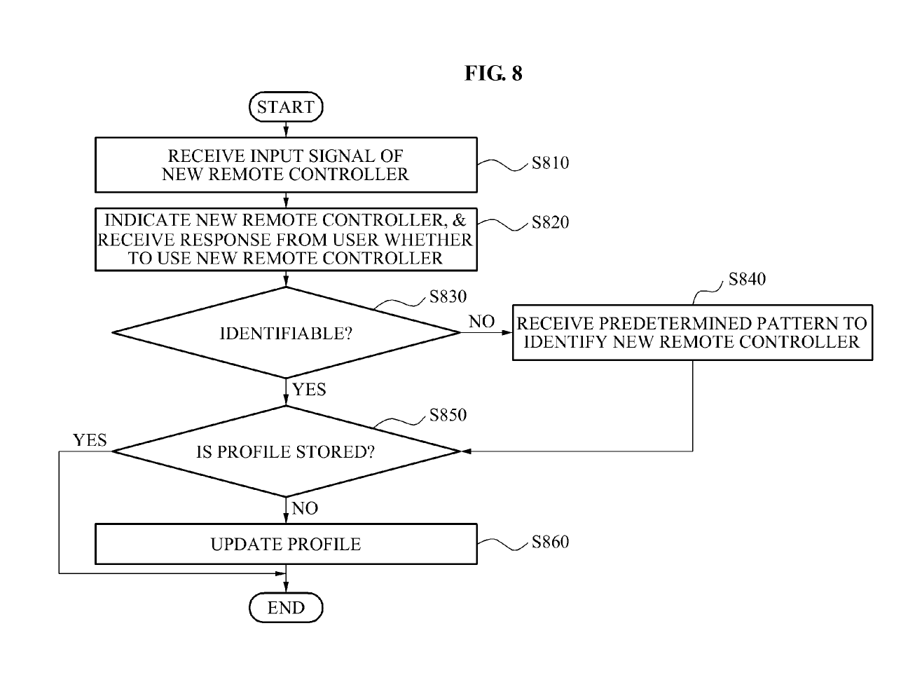

FIG. 8 is a flowchart illustrating a method of recognizing, by the remote controller supporting system 110, a new remote controller according to an embodiment of the present invention.

FIG. 8 illustrates a process of recognizing, by the remote controller supporting system 110, the remote controller 120 when the remote controller supporting system 110 initially accesses the remote controller 120, or when a user desires to use the new remote controller in the remote controller supporting system 110.

In operation S810, the receiver 112 may receive an input signal of the new remote controller.

In operation S820, when the input signal is not transmitted from the existing remote controller 120, the receiver 112 may indicate the new remote controller, and may receive a response from the user about whether to use the new remote controller.

In operation S830, the receiver 112 may verify whether a type of the new remote controller is identifiable based on the received input signal.

When the type of the new remote controller is unidentifiable, the receiver 112 may request the user for a predetermined pattern to identify the new remote controller, and may receive the predetermined pattern from the user in operation S840. The receiver 112 may identify the type of the new remote controller based on the predetermined pattern received from the user.

In operation S850, the receiver 112 may verify whether a profile corresponding to the identified type of the new remote controller is stored in the profile storage unit 111. When the corresponding profile is stored in the profile storage unit 111, the receiver 112 may perform operation S710 of interpreting the input signal based on the profile.

When the corresponding profile is not stored in the profile storage unit 111, the receiver 112 may execute the profile updater 115 to update a new profile corresponding to the new remote controller to the profile storage unit 111 in operation S860.

The profile updater 115 may select and access at least one of external storage media storing profiles based on the identified type of the new remote controller, download the new profile corresponding to the new remote controller, and store the downloaded new profile in the profile storage unit 111.

As described above, according to an embodiment of the present invention, it is possible to provide a web service optimized for a remote controller of a user by managing a webpage with different functions according to functions of each remote controller, and by transmitting a webpage suitable for the remote controller of the user based on functions included in the remote controller of the user.

Also, it is possible to provide a web service optimized for a remote controller of a user by enabling a remote controller supporting system to combine functions available in the remote controller of the user, to recreate a webpage, and to display the recreated webpage when a web server transmits all the available functions.

The remote controller supporting method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A remote controller supporting system, comprising:
a webpage storage unit to store a different webpage for each remote controller according to functions supportable by each remote controller; and
a function controller to transmit remote controller group information containing remote controllers and webpage information corresponding to each of the remote controllers, and to transmit a webpage corresponding to a remote controller used in a system receiving the remote controller group information according to a request of the system.

2. The remote controller supporting system of claim 1, wherein the system receiving the remote controller group information verifies a remote controller group containing a remote controller used by the remote controller supporting system, based on the received remote controller group information, and requests a web server for a webpage corresponding to the corresponding remote controller.

3. The remote controller supporting system of claim 1, further comprising:
a profile storage unit to store profiles of remote controllers supported by the remote controller supporting system,
wherein the function controller sets the different webpage for each of the remote controllers based on a corresponding profile, and stores the set webpage in the webpage storage unit.

4. A remote controller supporting system, comprising:
a profile storage unit to store a plurality of profiles containing functions of remote controllers and information associated with the functions;
a receiver to receive an input signal from a predetermined remote controller, and to interpret a meaning of the input signal based on a profile corresponding to the predetermined remote controller;
an event unit to transform the meaning of the input signal to an event form; and
a presentation unit to access a web server to display a webpage, to transform, to a predetermined behavior, at least one event transformed by the event unit, and to request the web server for an operation corresponding to the behavior,
wherein the presentation unit receives information associated with functions of the webpage from the web server to display the webpage where the functions of the webpage are matched with the respective functions of the predetermined remote controller.

5. The remote controller supporting system of claim 4, wherein the presentation unit comprises:
a function matching unit to access the web server to receive information associated with the functions of the webpage, and to display the webpage where the functions of the webpage are matched with the respective functions of the predetermined remote controller;
a storage unit to store a behavior list containing behaviors and at least one event corresponding to each of the behaviors;
a buffer to sequentially receive an event from the event unit; and
an interpreter to verify whether a behavior matching the at least one event exists in the behavior list by comparing the at least one event stored in the buffer with the behavior list, and to transform the matching at least one event to the verified behavior when the behavior matching the at least one event is included in the behavior list.

6. The remote controller supporting system of claim 5, wherein the web server provides the presentation unit with integral information associated with all functions supportable by the webpage.

7. The remote controller supporting system of claim 6, wherein the function matching unit compares the integral information with the profiles to extract information corresponding to the predetermined remote controller, recreates the webpage so that the functions of the webpage are matched with the respective functions of the predetermined remote controller, and displays the recreated webpage.

8. The remote controller supporting system of claim 5, wherein the web server groups the plurality of remote controllers based on functions supportable by each remote controller to generate at least one remote controller group, stores a different webpage for each of the at least one remote controller group, and provides remote controller group information to the presentation unit.

9. The remote controller supporting system of claim 8, wherein the function matching unit compares the remote controller group information with the profiles to verify a remote controller group including the predetermined remote controller, loads, from the web server, a webpage corresponding to the predetermined remote controller, and displays the loaded webpage.

10. The remote controller supporting system of claim 5, wherein, when the presentation unit is connected to the web server, the interpreter retrieves, from the storage unit, a behavior list used in the web server to load the retrieved behavior list.

11. The remote controller supporting system of claim 5, wherein the interpreter deletes, from the buffer, the at least one event transformed to the verified behavior.

12. The remote controller supporting system of claim 4, further comprising:
a profile updater to access an external storage medium storing a new profile to download the new profile, and to store the downloaded new profile in the profile storage unit.

13. The remote controller supporting system of claim 12, wherein:
the receiver identifies the predetermined remote controller based on the input signal, and
when the predetermined remote controller is unidentifiable based on the input signal, the receiver receives a predetermined pattern from a user to identify the predetermined remote controller.

14. The remote controller supporting system of claim 13, wherein:
the receiver retrieves a profile corresponding to the identified remote controller from the profile storage unit, and
when the profile corresponding to the identified remote controller does not exist in the profile storage unit, the receiver executes the profile updater to store a new profile corresponding to the remote controller in the profile storage unit.

15. The remote controller supporting system of claim 13, wherein the external storage medium storing the new profile corresponds to one of a storage unit of the remote controller, the web server, and a database server.

16. A remote controller supporting method, comprising:
storing and setting a different webpage for each remote controller according to functions supportable by each remote controller;
transmitting remote controller group information containing remote controllers and webpage information corresponding to each of the remote controllers; and
transmitting a webpage corresponding to a remote controller used in a system receiving the remote controller group information according to a request of the system.

17. A remote controller supporting method, comprising:
receiving, from a web server, integral information associated with all functions supportable by a webpage included in the web server;
comparing the integral information with functions of a using remote controller to extract information corresponding to the using remote controller;
recreating the webpage so that functions of the webpage are matched with the respective functions of the remote controller based on the extracted information; and
displaying the recreated webpage.
